(19) United States
(12) Patent Application Publication
(10) Pub. No.: US 2017/0103033 A1
(43) Pub. Date: Apr. 13, 2017

(54) DECODER FOR A MODEL TRAIN AND METHOD OF OPERATING A DECODER FOR A MODEL TRAIN

(71) Applicant: Throttle Up! Corp., DBA SoundTraxx, Durango, CO (US)

(72) Inventors: George Anthony Bogatiuk, III, Bayfield, CO (US); Jarrette Scott Ireland, Bayfield, CO (US); Joel Butler, Springfield, MO (US); Daniel Szabo, Durango, CO (US); Steven Dominguez, Durango, CO (US)

(21) Appl. No.: 15/316,015

(22) PCT Filed: Jun. 4, 2015
(86) PCT No.: PCT/US15/34204

§ 371 Date: Dec. 2, 2016

Related U.S. Application Data
(60) Provisional application No. 62/007,851, filed on Jun. 4, 2014.

(51) Int. Cl. G06F 13/364; A63H 19/10; G06F 13/40; G05B 17/02; G06F 13/42; A63H 19/24; G05B 19/042

(52) U.S. Cl. CPC G06F 13/364; A63H 19/24; A63H 19/10; G05B 19/042; G05B 17/02; G06F 13/4282; G06F 13/404; G05B 2219/23456

(57) ABSTRACT

A decoder for model train locomotives or rolling stock including: a data input; a sensor, separate from the data input and arranged to receive a first energy signal and transmit a first trigger signal; a memory element configured to store a first address identifying the decoder; and a processor configured to receive first data including a group identity address, receive the first trigger signal; and store the group identity address in the memory element. The sensor is arranged to: receive a second energy signal; and transmit, in response to receiving the second energy signal, a second trigger signal. The processor is configured to: receive the second trigger signal; receive second data including the first address and first operating instructions, associated with the first address, for a device for a model train locomotive or rolling stock; and transmit the first operating instructions. The group identity address identifies a group of decoders.

### CROSS-REFERENCE TO RELATED APPLICATIONS

This application is the United States National Stage Application pursuant to 35 U.S.C. §371 of International Patent Application No. PCT/US2015/034204, filed on Jun. 4, 2015, and claims the benefit under 35 U.S.C. §119(e) of U.S. Provisional Patent Application No. 62/007,851, filed Jun. 4, 2014, which applications are incorporated herein by reference in their entireties.

### FIELD

The present disclosure relates to a decoder for a model train, a plurality of decoders for a model train and a method for operating a decoder for a model train. In particular, a decoder enters into a group operating mode with external energy signals and then each decoder in the group receives group operating instructions in a single data stream.

### BACKGROUND

FIG. 1 is a block diagram of a simplified prior art master-slave data bus architecture. In the industry of hobby electronics it is often desirable to communicate to various electronic mobile receivers (referred to as slaves) using digital protocols. This communication is often achieved by a control station (referred to as master) communicating to various mobile receivers. The mobile receivers are placed within a hobby model to implement various controls such as but not limited to motion control, lighting, sound, etc.

FIG. 2 is a block diagram of a prior art master-slave data bus with communication between one master and one slave. FIG. 3 is a block diagram of a prior art master-slave data bus with communication between one master and a group of three grouped/linked slaves. Each mobile receiver is operated under its own unique address. It is often desirable to link multiple mobile receivers together for operation under one set of digital commands so that a single control station is permitted to communicate to multiple mobile receivers via a single command sent via a group address instead of multiple commands sent via each individual receivers address as shown in FIG. 3. In this state the mobile receiver still maintains its own unique address but receives commands from the control station under a group address. Configuring the slave devices known as mobile receivers to respond properly to a single master control station has typically required a lengthy and complicated setup process. This process on existing designs requires the use of multiple configurable values sent to each individual mobile receiver via an individual digital command for each variable including the group of receivers address, preferred effects, and performance.

For example, specifically looking at model railroads, for five mobile receivers that need to work together in a group, typically called a consist, the desired result is to take all five mobile receivers, which in their current state have individual unique addresses, and give each a single uniform address that each receive may respond to without losing their primary address when the desire to eliminate the consist takes place. The existing designs require the operator to change addresses for each individual mobile receiver via the control station using a predefined programming mode or modes that require the operator to exit the normal operating mode and set each address individually to place them into a common consist address. This is an undesirable characteristic since the operator loses control of the consist because the receivers must leave the current operating state.

FIG. 4 is a flow chart outlining the steps required within prior art for individually configuring the consist address for N-number of slaves. On a state-of-the-art Digital Command Control (DCC) equipped model train layout, all of the model train pieces of equipment (locomotives and cars) contain a mobile DCC decoder, (acting as the mobile receiver) and the layout is operated via a command station, (acting as the control station). Entering a consist state typically requires the following steps:

1. Operating mode.

2. Enter the programming mode (this exits the operating mode).

3. Select the primary slave address of intended mobile receiver (DCC decoder).

4. Enter configuration variable corresponding to the consist address parameter.

5. Enter new consist address into mobile receiver.

6. Exit programming mode to return to operating mode and repeat steps 2-5 for next mobile receiver for n number of receivers desired in consist operation.

7. Exit back to Operating mode.

Each of the above steps may involve multiple keystrokes on the user interface, which can be very cumbersome. In addition some user interfaces are such that they can require lengthy and complicated user tutorials and detailed manuals just to complete the seven steps outlined above.

Another shortcoming of known designs is a slave not included within a linked consist does not monitor bus communication activity for addresses other than the primary address of the slave. Unfortunately, the slaves outside of the consist do not have any awareness or knowledge concerning the state of the active operating consists such as sounds, motor commands, lighting effects, braking functions, etc. Therefore, if one of these slaves is added to the consist, all of these state parameters would need to be updated to synchronize to the rest of the consist. For example, referring to FIG. 3, slave 4 was not linked to the original consist and therefore has been ignoring the communication state in the consist of slaves 1-3.

### SUMMARY

According to aspects illustrated herein, there is provided a plurality of decoders for model train locomotives or rolling stock, including first and second decoders. The first decoder includes: a first memory element configured to store a first address uniquely identifying the first decoder; and a first processor configured to receive first data including a group identity address; and store the group identity address in the first memory element. The second decoder includes: a second memory element configured to store a second address uniquely identifying the second decoder; and a second processor configured to receive the first data and store the group identity address in the second memory element. The group identity address identifies a group of decoders. The first decoder is arranged for installation in a first model train locomotive or rolling stock. The second decoder is arranged for installation in a second model train locomotive or rolling stock.

According to aspects illustrated herein, there is provided a plurality of decoders for model train locomotives or rolling stock, including first and second decoders. The first decoder includes: a first data input; a first sensor, separate from the first data input, the first sensor arranged to receive a first energy signal and transmit, in response to receiving the first energy signal, a first trigger signal; a first memory element configured to store a first address uniquely identifying the first decoder; and, a first processor. The first processor is configured to: receive first data including a group identity address and group operating instructions including first group operation instructions, for first and second devices for first and second model train locomotive or rolling stock, respectively; receive the first trigger signal; and in response to receiving the first trigger signal store the group identity address in the first memory element and transmit the first operating instructions. The second decoder includes: a second data input; a second sensor, separate from the second data input, the second sensor arranged to receive a second energy signal and transmit, in response to receiving the second energy signal, the first trigger signal; a second memory element configured to store a second address uniquely identifying the second decoder; and a second processor configured to receive the first data; receive the first trigger signal; and in response to receiving the first trigger signal store the group identity address in the first memory element and transmit the second operating instructions. The group identity address identifies a group of decoders. The first decoder is arranged for installation in a first model train locomotive or rolling stock. The second decoder is arranged for installation in a second model train locomotive or rolling stock.

According to aspects illustrated herein, there is provided a decoder for model train locomotives or rolling stock, including: a data input; a sensor, separate from the data input, the sensor arranged to receive a first energy signal and transmit, in response to receiving the first energy signal, a first trigger signal; a memory element configured to store a first address identifying the decoder; and a processor configured to receive first data including a group identity address, receive the first trigger signal; and in response to receiving the first trigger signal, store the group identity address in the memory element. The sensor is arranged to: receive a second energy signal; and transmit, in response to receiving the second energy signal, a second trigger signal. The processor is configured to: receive the second trigger signal; receive second data including the first address and first operating instructions, associated with the first address, for a device for a model train locomotive or rolling stock; and transmit the first operating instructions. The group identity address identifies a group of decoders.

According to aspects illustrated herein, there is provided a computer-based method for operating a decoders for a model train locomotive or rolling stock, including: receiving, using a sensor for the decoder, a first energy signal; transmitting, using the sensor and in response to receiving the first energy signal, a first trigger signal; storing, in a memory element for the decoder, a first address identifying the decoder; receiving, using a processor for the decoder, first data including a group identity address; receiving, using the processor, the first trigger signal; in response to receiving the first trigger signal, storing, using the processor, the group identity address in the memory element; receiving, using the sensor, a second energy signal; transmitting, using the sensor and in response to receiving the second energy signal, a second trigger signal; receiving, using a processor, the second trigger signal; receiving, using the processor, second data including the first address and first operating instructions, associated with the first address, for a device for a model train locomotive or rolling stock; transmitting, using the processor, the first operating instructions; and identifying, using the processor and the group identity address, a group of decoders.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a block diagram of a simplified prior art master-slave data bus architecture;

FIG. 2 is a block diagram of a prior art master-slave data bus with communication between one master and one slave;

FIG. 3 is a block diagram of a prior art master-slave data bus with communication between one master and a group of three grouped/linked slaves;

FIG. 4 is a flow chart outlining the steps required within prior art for individually configuring a group address for N-number of slaves;

FIG. 5 is a schematic block diagram of a plurality of decoders for model train locomotives or rolling stock;

FIG. 6 is a block diagram illustrating example steps for adding an additional decoder of FIG. 5 to a group of three decoders;

FIG. 7 is a block diagram illustrating example steps for adding multiple decoders of FIG. 5 to a group of three decoders;

FIG. 8 is a flow chart outlining the example steps for adding for configuring the group address for N-number of decoders of FIG. 5;

FIG. 9 is a block diagram illustrating an example data bus monitoring characteristic of the decoder of FIG. 6;

FIG. 10 is a block diagram outlining example processing architecture of the decoder of FIG. 5;

FIG. 11 is an example state machine diagram applicable to the decoder of FIG. 5; and,

FIG. 12 is a block diagram outlining example processing architecture of the decoder of FIG. 5.

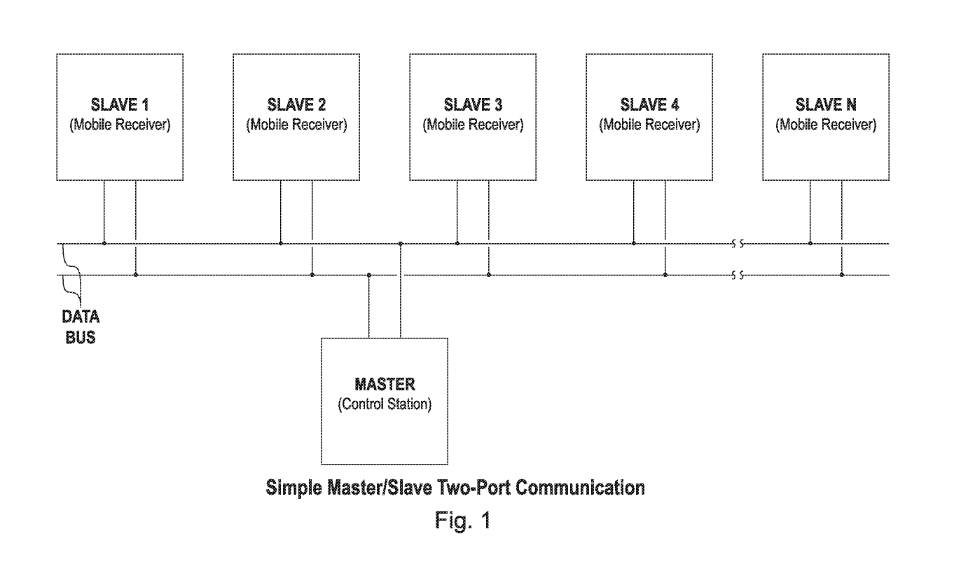

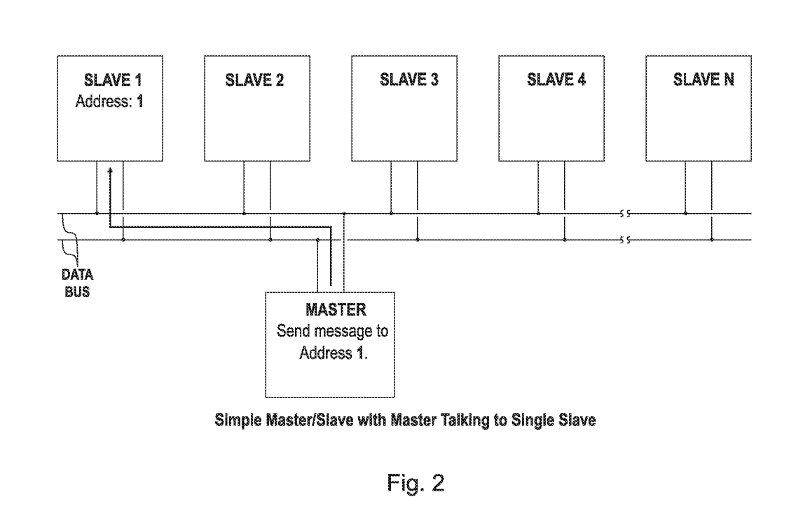

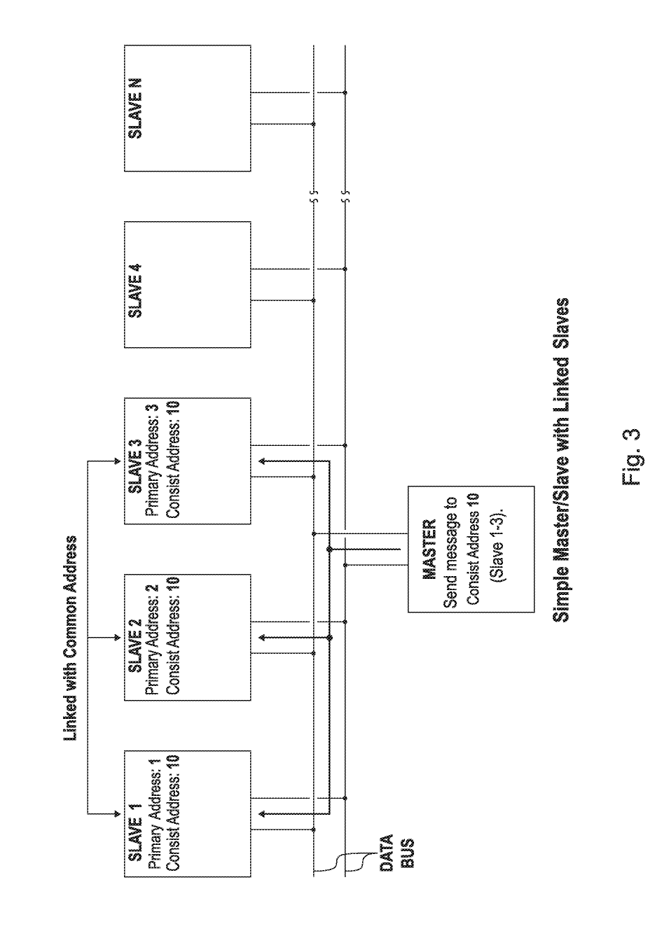

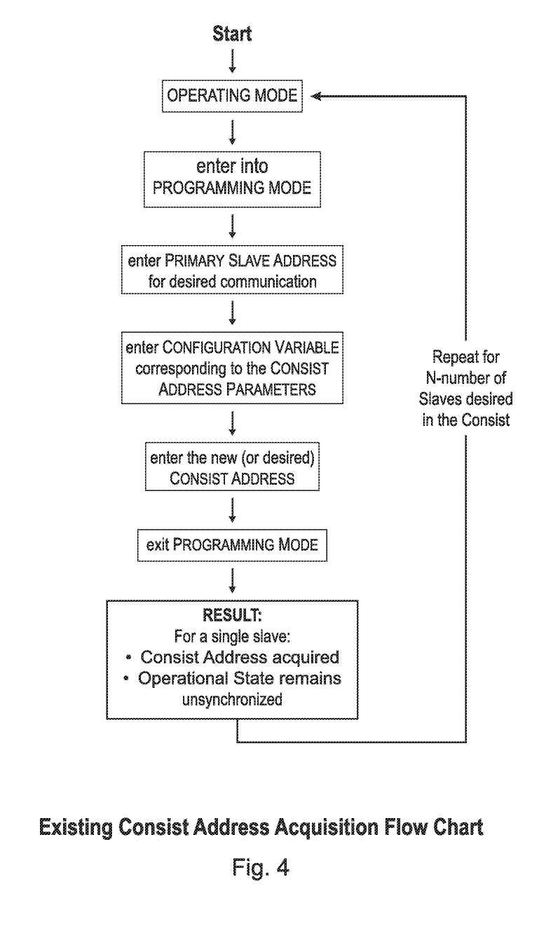

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

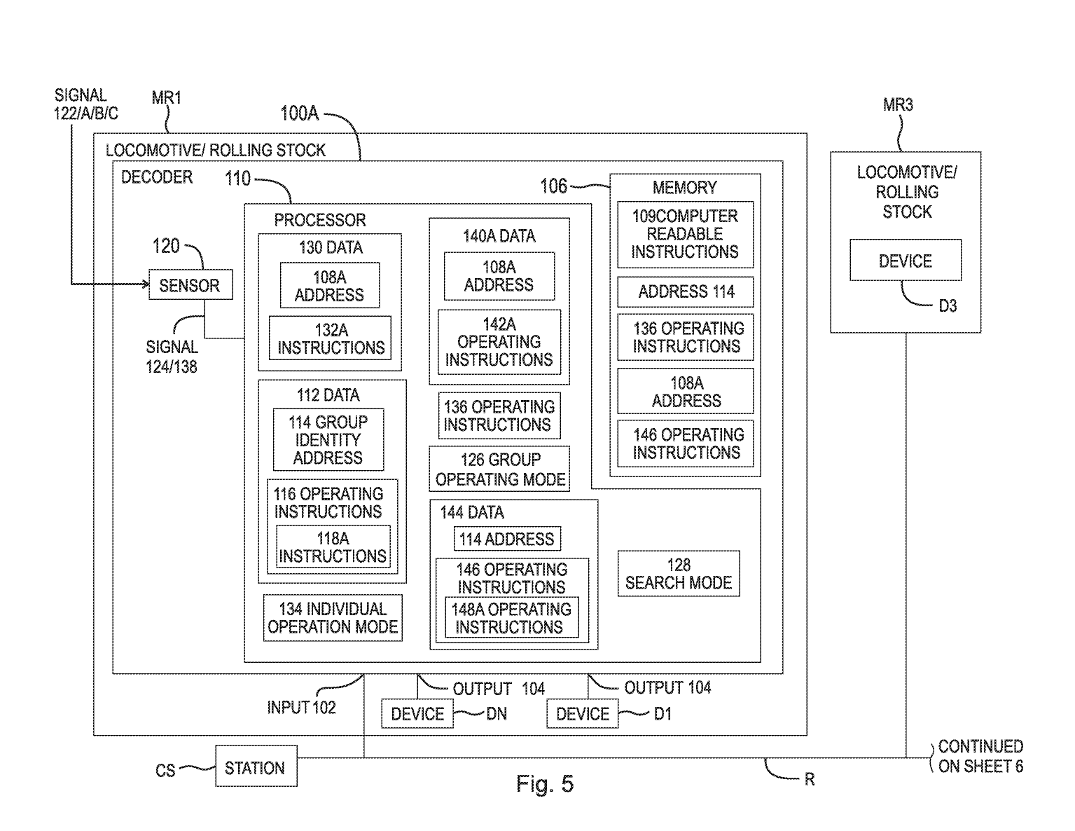

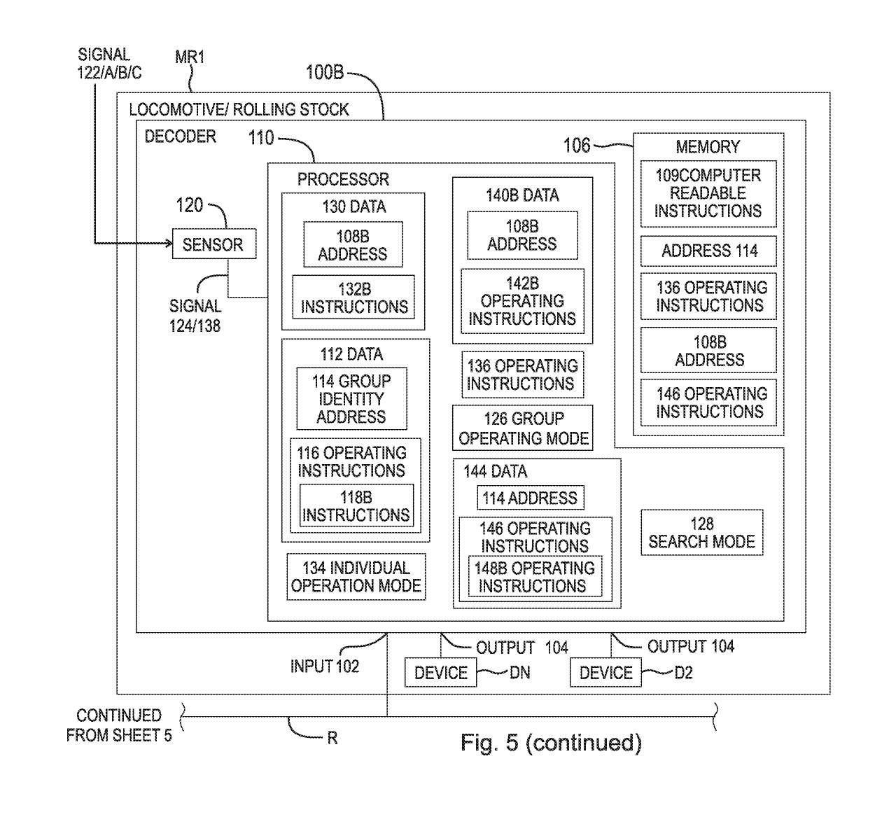

FIG. 5 is a schematic block diagram of a plurality of decoders for model train locomotives or rolling stock. For purposes of describing the operation of multiple decoders 100, decoders 100A and 100B are shown and described in FIG. 5. Decoders 100A and 101B include: data input 102; output 104; memory element 106 configured to store computer readable instructions 109; and processor 110. For decoder 101A, memory 106 is configured to store address 108A identifying decoder 100A. For decoder 101B, memory element 106 is configured to store address 108B identifying decoder 100B. In an example embodiment, address 108A uniquely identifies decoder 100A and/or address 108B uniquely identifies decoder 100B. In an example embodiment, input 102 also is a power input.

For decoder 101A, processor 110 is configured to: receive, for example, via data input 102, data 112 including group identity address 114; and store group identity address 114 in memory element 106. In an example embodiment, group identity address 114 is different from address 108A. For decoder 101B, processor 110 is configured to: receive, for example, via data input 102, data 112 including group identity address 114; and store group identity address 114 in memory element 106. In an example embodiment, group identity address 114 is different from address 108B.

Processor 110 and memory element 106 can be any processor or memory element, respectively, known in the art. It should be understood that unless indicated otherwise, operations described below for processor 110 are implemented by executing instructions 109.

Group identity address 114 identifies a group, or consist of decoders 100. In the example of FIG. 5, decoders 100A and 100B are part of a group, or consist. However, it should be understood that any number of decoders 100 can be included in a group, or consist.

Decoder 100A is arranged for installation in model train locomotive or rolling stock MR1. Decoder 100B is arranged for installation in model train locomotive or rolling stock MR2. By “rolling stock” we mean any model train car other than a locomotive, for example, a passenger car, a freight car, or a caboose. By “operating instructions” we mean instructions for activating, deactivating, and otherwise controlling operation of the device.

Data 112 includes group operating instructions 116 for each decoder included in a particular group, or consist, for example, decoders 101A and 101B in the example of FIG. 5. For decoder 101A, processor 110 is configured to: select, from group operating instructions 116, operating instructions 118A for device D1 for model train locomotive or rolling stock MR1; and transmit, for example via output 104, operating instructions 118A, for example to device D1. For decoder 101B, processor 110 is configured to: select, from group operating instructions 116, operating instructions 118B for device D2 for model train locomotive or rolling stock MR2; and transmit, for example via output 104, operating instructions 118B, for example to device D2. Devices D1 and D2 can be any device known in the art, including, but not limited to a speaker or other audio device, a lighting device, or a motor.

Decoder 100 can include a single output 104 arranged for connection to a device such as device D1 or D2, or a plurality of outputs arranged for connection to a respective plurality of devices. For example, a second output 104 is connected to device DN. Any number of outputs can be included in the plurality of outputs for decoders 100A and 100B.

In the example of FIG. 5, decoders 100A and 100B and model train locomotive or rolling stock MR1 and MR2 are included in a Digital Command Control (DCC) equipped model train system. For example, model train locomotive or rolling stock MR1 and MR2 are in contact with rail R which acts as a power and data bus as is known in the art. In this example, input 102 receives data, such as data 112, via model train locomotive or rolling stock MR1 and MR2. Rail R is connected to command station CS. Data received by input 102 originates from command station CS. Although decoders 100A and 100B are shown in a DCC system, it should be understood that decoders 100A and 100B are usable with other power and data control configurations.

Decoders 100A and 100B include sensor 120, separate from electrical power and data input 102. Sensor 120 is arranged to: receive energy signal 122A; and transmit, in response to receiving energy signal 122A, trigger signal 124. Processor 110 is configured to: receive trigger signal 124; and in response to receiving trigger signal 124: enter group operating mode 126; select group identity address 114; and store group identity address 114 in memory element 106. For decoder 101A, processor 110 is configured to transmit operating instructions 118A. For decoder 101B, processor 110 is configured to transmit operating instructions 118B

Sensor 120 can be any sensor known in the art, including, but not limited to, a magnetic sensor or an electromagnetic sensor. For example, sensor 120 responds to energy signal 112A in the form of a magnetic or electromagnetic stimulus to provide signal 124.

In an example embodiment, processor 110 is configured to: enter search mode 128 in response to receipt of trigger signal 124. While in the search mode, processor 110 is configured to: ascertain that the data 112 includes group identity address 114. In response to ascertaining that data 112 includes group identity address 114, processor 110 is configured to enter into group operating mode 126.

In an example embodiment, during the search mode, processor 110 is configured to: receive, via electrical power and data input 102, data 130. For decoder 101A, data 130 includes address 108A and operating instructions 132A for device D1 and processor 110 is configured to transmit, via output 104, operating instructions 132A. For decoder 101B, data 130 includes address 108B and operating instructions 132B for device D2 and processor 110 is configured to transmit, via output 104, operating instructions 132B. Thus, while decoders 100A and 100B are in the search mode, the decoders can continue to operate in individual operation mode 134. Individual operation mode 134 is characterized by operating instructions associated with the address for a single decoder and directed solely to the decoder identified by the address.

In an example embodiment, during the search mode, processor 110 for decoder 101A is configured to: receive, via electrical power and data input 102, data 112; and store operating instructions 118A in memory element 106. Upon entry into the group operating mode, processor 110 is configured to transmit instructions 118A stored memory element 106. For decoder 100B, processor 110 is configured to: receive, via electrical power and data input 102, data 112; and store operating instructions 118B in memory element 106. Upon entry into the group operating mode, processor 110 is configured to transmit instructions 118B stored memory element 106. Thus, as soon as processor 100 enters the group operating code, the decoder can immediately implement operating instructions 118A or 118B without waiting for the next iteration of operating instructions 118A or 118B to be received via input 102.

In an example embodiment, during the search mode, processor 110 is configured to: receive, for example, via data input 102, operating instructions 136 for device D3 for model train locomotive or rolling stock MR3; and store operating instructions 136 in memory element 106. Thus, operational data for other locomotives and rolling stock is accessible by processor 110 and is usable by processor 110 to coordinate operation of device D1 with other devices that may interface with device D1.

In an example embodiment, during the group operating mode, processor 110 is configured to: receive, for example via data input 102, operating instructions 136 for device D3 for model train locomotive or rolling stock MR3; and store operating instructions 136 in memory element 106. Thus, operational data for other locomotives and rolling stock is accessible by processor 110 and is usable by processor 110 to coordinate operation of device D1 with other devices that may interface with device D1.

Sensor 120 is configured receive energy signal 122B and transmit, in response to receiving the energy signal 122B, trigger signal 138. Processor 110 for decoder 101A is configured to: receive trigger signal 138; receive, for example via data input 102, data 140A including address 108A and operating instructions 142A, associated with address 108A, for device D1; enter, in response to receiving the trigger signal 138, individual operation mode 134; and transmit, for example, via output 104, instructions 142A. Thus, upon receipt of a second energy signal, decoder 100A toggles to the individual operation mode.

For decoder 100B, processor 110 is configured to: receive trigger signal 138; receive, for example, via data input 102, data 140B including address 108B and operating instructions 142B, associated with address 108B, for device D2; enter, in response to receiving the trigger signal 138, individual operation mode 134; and transmit, for example via output 104, instructions 142B. Thus, upon receipt of a second energy signal, decoder 100B toggles to the individual operation mode.

In an example embodiment, during the individual operation mode, processor 110 is configured to: receive, for example via data input, data 144 including group identity address 114 and group operating instructions 146; and store group identity address 114 and instructions 146 in memory element 106. For decoder 101A, group operating instructions 146 include operating instructions 148A for device D1. For decoder 100B, group operating instructions 146 include operating instructions 148B for device D2. Thus, during the individual operation mode, decoder 100 is able to store the latest instructions for a particular group.

In an example embodiment, during the individual operation mode, sensor 120 is arranged to receive energy signal 122C; and transmit, in response to receiving energy signal 122C, trigger signal 138. Processor 110 is configured to: receive trigger signal 138; and enter into the group operating mode. For decoder 101A, processor 110 is configured to transmit operating instructions 118A; and transmit operation instructions 148A stored in memory element 106. For decoder 100B, processor 110 is configured to: receive trigger signal 138; enter into the group operating mode; and transmit operation instructions 148B stored in memory element 106. Thus, as soon as processor 100 enters the group operating code, the decoder can immediately implement operating instructions 148A and 148B without waiting for the next iteration of operating instructions 148A and 148B to be received via input 102.

In an example embodiment, processor 110 for decoder 101A is configured to: compare operating instructions 142A and 148A; and modify operating instructions 142A as needed to avoid conflict with operating instructions 148A. For decoder 100B, processor 110 is configured to: compare operating instructions 142B and 148B; and modify operating instructions 142B as needed to avoid conflict with operating instructions 148B. That is, when entering the group operating mode from the individual operation mode, processor 110 modifies instructions associated with the individual operation mode to avoid conflict with operations associated with the group operating mode. For example, if instructions 142A included sound effects for braking a freight car and instructions 148A included sound affects for accelerating the freight car, the processor would not implement the braking sound effects.

Advantageously, decoder 100 addresses the problem noted above for prior art consists. Rather than leaving an operating mode to separately access each decoder included in a consist, or group, and then individually program each decoder with consist information, such as instructions 116, each decoder in a group can be quickly and easily entered into the search mode by use of energy signal 122, for example by passing a magnet over the sensor for each decoder in the group. Then, a single command or data stream, such as data 112 is sent out, for example, from station CS on rail R, with the operating instructions (e.g., instructions 116/118A) for every decoder in the consist. Every decoder in the search mode selects the data stream and implements the data stream. That is, the programming for a consists needs to be performed only one time and then sent in a single data stream to each decoder in the consist.

The following should be viewed in light of FIG. 5. The following describes a computer-based method for operating a decoders for a model train locomotive or rolling stock. Although the method is presented as a sequence of steps for clarity, no order should be inferred from the sequence unless explicitly stated. A first step receives, using a sensor for the decoder, a first energy signal. A second step transmits, using the sensor and in response to receiving the first energy signal, a first trigger signal. A third step stores, in a memory element for the decoder, a first address identifying the decoder. A fourth step receives, using a processor for the decoder, first data including a group identity address. A fifth step receives, using the processor, the first trigger signal. A sixth step, in response to receiving the first trigger signal, stores, using the processor, the group identity address in the memory element. A seventh step receives, using the sensor, a second energy signal. A eighth step transmits, using the sensor and in response to receiving the second energy signal, a second trigger signal. A ninth step receives, using a processor, the second trigger signal. A tenth step receives, using the processor, second data including the first address and first operating instructions, associated with the first address, for a device for a model train locomotive or rolling stock. An eleventh step transmits, using the processor, the first operating instructions. A twelfth step identifies, using the processor and the group identity address, a group of decoders.

In an example embodiment: the first data includes group operating instructions for the group of decoders, the group operating instructions include second operating instructions for the device, and a thirteenth step, in response to receiving the first trigger signal, transmits, using the processor, the second operating instructions. In an example embodiment, the second operating instructions are different from the first operating instructions.

The following should be viewed in light of FIG. 5. The following describes a computer-based method for controlling respective devices for a plurality of model train locomotives or rolling stock. Although the method is presented as a sequence of steps for clarity, no order should be inferred from the sequence unless explicitly stated. A first step stores, in a first memory element for a first decoder, a first address identifying the first decoder. A second step receives, using a first sensor for the first decoder, a first energy signal. A third step transmits, using the first sensor and in response to receiving the first energy signal, a first trigger signal. A fourth step receives, using a first processor for the first decoder and via a first data input different from the first sensor, first data including first group operating instructions and a group identity address, the group identity address different from the first address. A fifth step receives, using the first processor, the first trigger signal. A sixth step, in response to receiving the first trigger signal: stores, using the first processor, the group identity address in the first memory element; and transmits, using the first processor, first operating instructions, included in the first group operation instructions, for a first device for a first model train locomotive or rolling stock. a seventh step stores, in a second memory element for a second decoder, a first address identifying the second decoder. An eighth step receives, using a second sensor for the second decoder, a second energy signal. A ninth step transmits, using the second sensor and in response to receiving the second energy signal, the first trigger signal. A tenth step receives, using a second processor for the second decoder and via a second data input different from the second sensor, the first data including the first group operating instructions and the group identity address, the group identity address different from the second address. An eleventh step receives, using the second processor, the first trigger signal. A twelfth step, in response to receiving the first trigger signal: stores, using the second processor, the group identity address in the second memory element; and transmits, using the second processor, second operating instructions, included in the first group operation instructions, for a second device for a second model train locomotive or rolling stock. The first group address identifies a plurality of decoders. The first decoder is arranged for installation in the first model train locomotive or rolling stock. The second decoder is arranged for installation in the second model train locomotive or rolling stock.

In an example embodiment, a thirteenth step, in response to receiving the first trigger signal: enters, using the first processor, a group operating mode; and transmits, using the first processor, the first operating instructions. A fourteenth step, during the group operating mode: receives, using the first processor and via the first electrical power and data input, second operating instructions for a third device for a third model train locomotive or rolling stock; and stores, using the first processor, the second operating instructions in the first memory element.

In an example embodiment: a fifteenth step receives, using the first sensor, a third energy signal. A sixteenth step transmits, using the first sensor and in response to receiving the third energy signal, a second trigger signal. A seventeenth step receives, using the first processor, the third trigger signal. An eighteenth step receives, using the first processor and via the first electrical power and data input, second data including the first address and third operating instructions, associated with the first address, for the first device. A nineteenth step enters, using the first processor and in response to receiving the second trigger signal, an individual operation mode. A twentieth step transmits, using the first processor and via the first output, the third operating instructions.

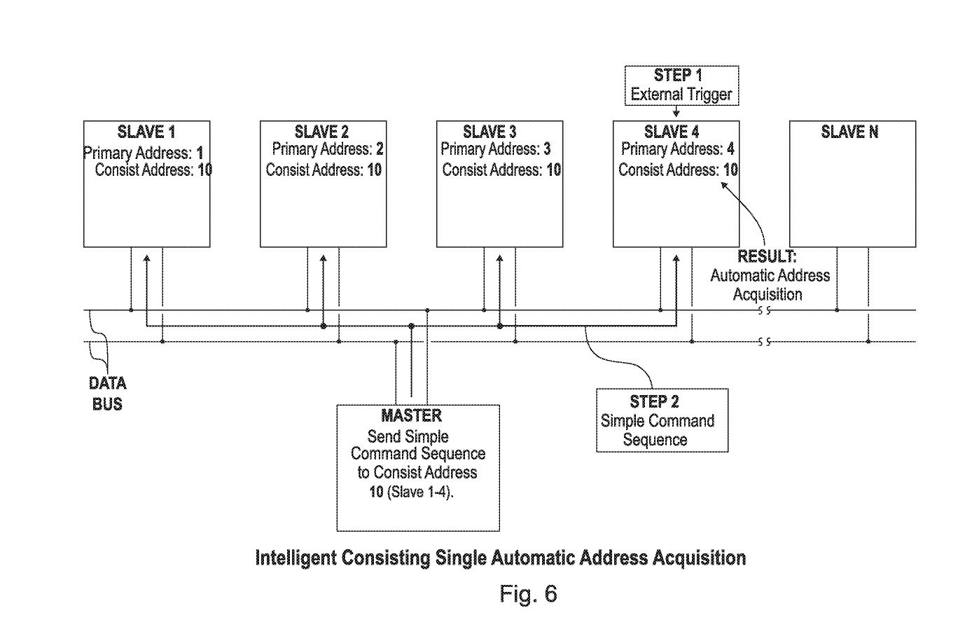

FIG. 6 is a block diagram illustrating example steps for adding an additional decoder of FIG. 5 to a group of three decoders. The following provides further information regarding decoder 100A and system 200. Decoder 100A, system 200 and the method described above, advantageously overcome the above-mentioned shortcomings of the known state of grouping, or consisting. For example, decoder 100A receives external sensory stimulus (signal) 122A to automatically enter the address-scanning search mode. Once in the search mode, decoder 100A monitors the bus (e.g., rail R) for predetermined, easily recognizable group identity address 124. This sequence enables the triggered decoder to automatically acquire the group, or consist, address without complicated programming modes.

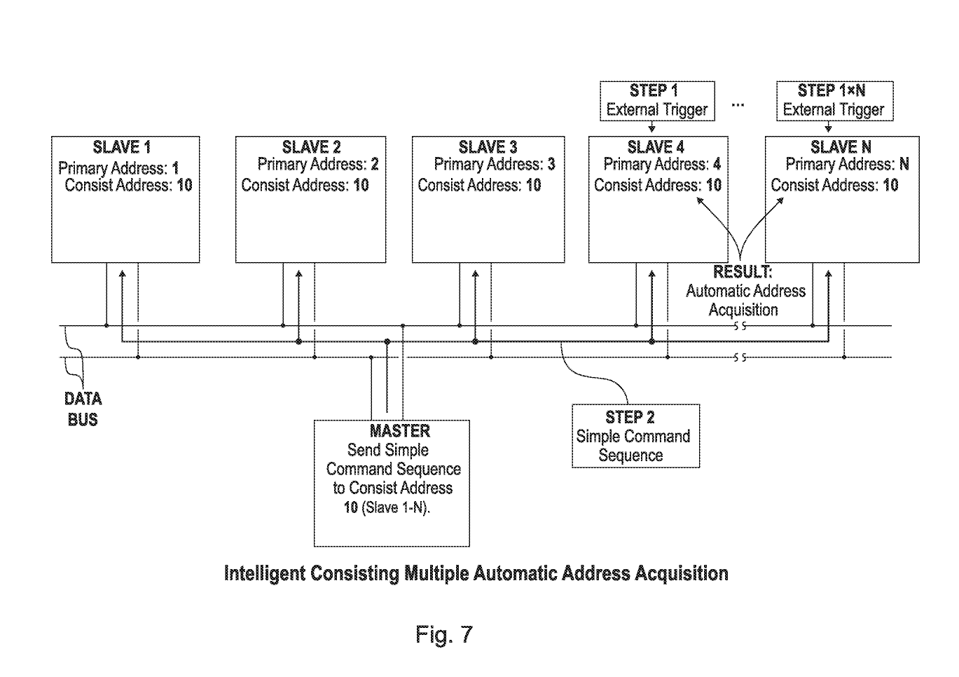

FIG. 7 is a block diagram illustrating example steps for adding multiple decoders of FIG. 6 to a group of three decoders. An additional benefit to the present disclosure architecture is that multiple slaves can be externally triggered prior to issuing data including group identity address 114, such that all triggered receivers are in search mode and ascertain group identity address 114 within one easily recognizable command sequence. In other words, multiple slave decoders can simultaneously acquire the consist identity data without repetitive steps to acquire each decoder. Thus, n number of slave decoders can be added to a consist in one simple sequence as shown in FIG. 7.

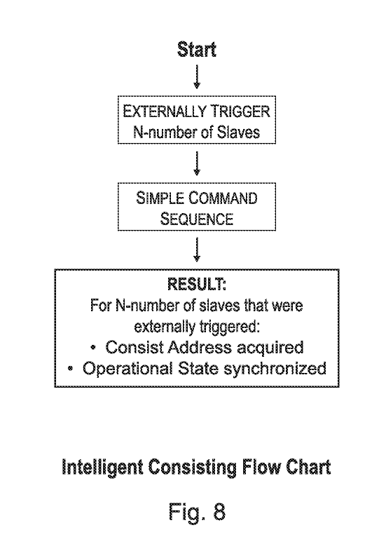

FIG. 8 is a flow chart outlining the example steps for adding the consist address for N-number of decoders of FIG. 6. For decoder 100A, the steps to acquire decoders into a consist are greatly reduced as follows:

1. Apply external trigger (e.g., energy signal 122A) to decoder to be added to the consist (repeat for each slave decoder to add to consist).

2. Apply simple command sequence. That is, send data 112 with group identity address 124 and applicable operating instructions (e.g., data 116).

The total number of steps are step 1*N number of receivers plus step 2.

Thus, the number of steps needed to enter decoders into the desired consist is greatly reduced. For example, in the prior art operation described above, adding five slave decoders into a consist would require a total of 30 operations. In contrast, five decoders 100 can be added to a consist in just six steps. Further, while adding decoders to the consist, an operator can remain in the operational mode at all times, thereby never losing control of the decoders being added to the consist or the decoders already in the consist.

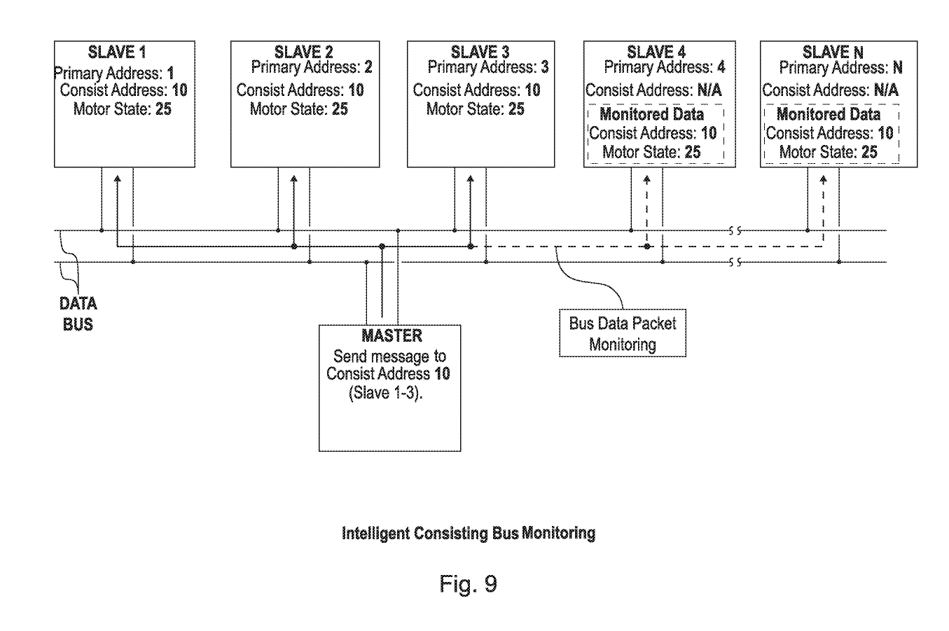

FIG. 9 is a block diagram illustrating an example data bus monitoring characteristic of the decoder of FIG. 6. In addition to the benefits mentioned above, system 200 and decoders 100A and 100B provide a technique by which all data packets transmitted by the master are monitored and stored. This storage is beneficial for use in synchronizing the operational states when entering or exiting other consisted slave decoders. In FIG. 9, slaves 1-3 are in a consist while slaves 4-N are not. Slaves 4-N are monitoring the data packets being received by the consist so that these slave decoder know the current state of the consist. Thus, slave decoders 4-N easily synchronize to the same state as the consist when decoders 4-N are added to the consist.

As another example, referring again to FIG. 9, the motor state of consist 10 has been set to 25. Slave 4 has been illustrated to show that it is monitoring the motor state of consist 10 even though it has not yet been added. This is beneficial for slave 4 when it is triggered and enters into consist 10 it will instantly know the motor state of the consist.

The operations of decoder 100A can be presented as an external triggering stage, a state machine stage, and a command sequence search stage. State machine, packet monitor, and command sequence search stages, described below, are typically implemented within a processor, microprocessor or similar microcontroller device, such as processor 110A.

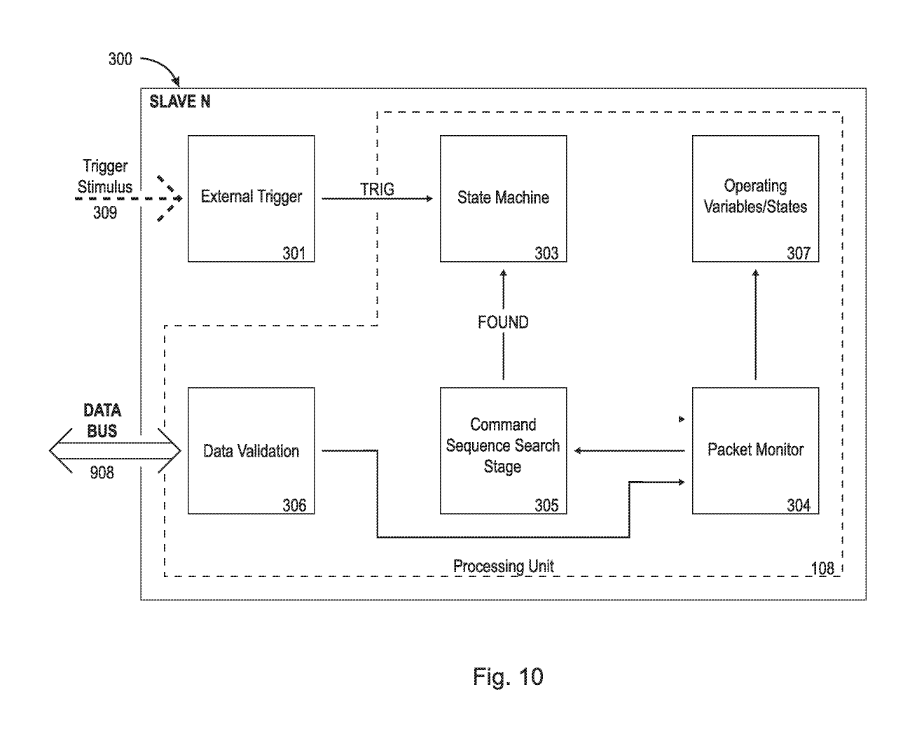

FIG. 10 is a block diagram outlining example processing architecture 300 of the decoder of FIG. 6. External triggering stage, 301, is operable to receive an input trigger stimulus, 309 (e.g., energy signal 122A), from outside the typical confines of the mobile electronic device, and produce output signal TRIG (e.g., trigger signal 124) for triggering the state monitor contained within processor 110A. Triggering signal TRIG is typically derived as a digital signal with traditional On/Off characteristics and is fed to the state machine stage, thus triggering the appropriate state changes.

As noted above, stimulus 309 can be, but is not limited to a magnetic or electromagnetic field. In an example embodiment, the external triggering stage contains one or more sensing elements to detect the presence or absence of the selected stimulus, 309. In an example embodiment, the external triggering stage is implemented with a simplified Hall-effect or reed switch sensor and generates active output signal TRIG when a magnetic stimulus is presented nearby the device. This technique allows the user to individually select and trigger multiple mobile devices without physically touching the selected device.

The Intelligent Consisting state machine, 303, is operable to receive external triggering signal TRIG and adjust to the appropriate logical state as needed. Typically, the state machine will operate in one of N different states. In an example embodiment, the intelligent consisting state machine supports three possible states: ON, OFF, or SEARCH, such that the state machine will operate in one of these three primary states. The state machine transitions between the N-different states through input triggering TRIG or other algorithmic inputs derived from other processing modules, such as the FOUND signal generated by the command sequence search stage, 305.

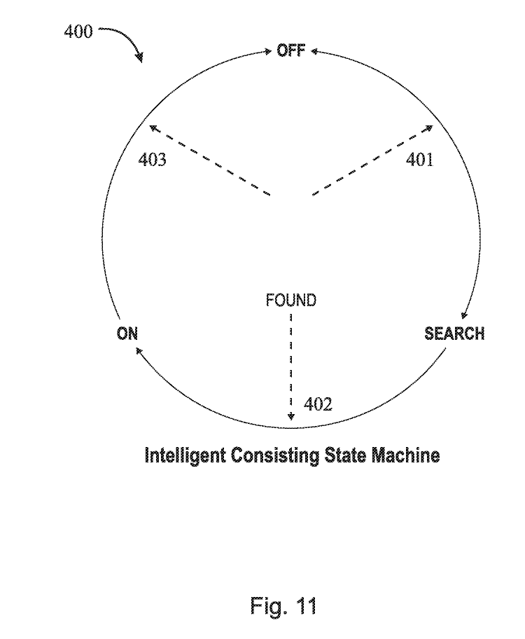

FIG. 11 is an example state machine diagram applicable to the decoder of FIG. 6. FIG. 11 is a simplified diagram of an example Intelligent Consisting state machine. The state machine determines the logical state of operation based upon external triggering signal TRIG and the address search module signal FOUND. When the Intelligent Consisting State Machine 400 is in the OFF state, the decoder is operating in a normal state, non-consisted or linked. During the OFF state, the decoder only responds to validated inbound data that is addressed specifically to the primary address of the device (e.g., address 108A). In other words, the decoder is responding to its own primary address and ignoring any consist addresses that are present on the bus.

Upon receiving a trigger signal TRIG from the external triggering stage, the state machine 400 transitions out of the OFF state and into the SEARCH state, as indicated by arrow 401. In the search state, the Intelligent Consisting state machine will wait for a predetermined period of time, enabling the command sequence search stage to watch for a valid command signal or sequence. Once the command sequence search stage has detected a valid command, it will activate the FOUND signal, informing the state machine that the a consist address has been received and the state can adjust as needed.

Upon receipt of a valid FOUND signal, the Intelligent Consisting state machine advances the state into the ON condition, indicating that the decoder has detected a valid consist address and is now operating in a consisted or linked mode, as indicated by arrow 402.

Optionally, to exit the SEARCH state or ON state, the TRIG signal, obtained from the external triggering stage, causes machine 400 to transition out of the SEARCH or ON states back into the OFF state, as indicated by arrows 403 or 401. In other words, when an operator desires to exit the intelligent consisted ON state, the external stimulus can be applied resulting in an active TRIG signal, which in turn transitions the state machine back into the OFF state (normal non-consisted operation).

Returning to FIG. 10, packet monitoring stage, 304, is an optional stage designed to receive validated data bus packets and derive from the packets a time sensitive data structure containing critical state information for other mobile electronic devices residing on the bus. This stage enables the decoder to effectively store the latest settings for a large number of other devices on the bus. In an example embodiment, the validated packet data are stored in a standardized data structure, such as an array, C-struct, heap, queue, or linked list. In an example embodiment, the validated information is stored in an array of C-structs. Each element with the array is comprised to store multiple pieces of information, such as address, speed, direction, functions, timing, and states.

During typical operation, packet monitor, 304, broadly operates using the following general tasks: (1) Receives a validated data packet detected on the bus 308, (2) Locates the effective address conveyed within the data packet, (3) traverses the data structure containing previously received data packets, and (4) stores the newly received data packet into the data structure node corresponding to the received address field. In some cases, each element within the packet monitoring data structure can be assigned a time stamp such that old or stale information can be removed if the packet monitor has not received any recent data corresponding to that specific address. For example, if the packet monitor has been receiving and storing information for a mobile electronic device with address twenty three, and a long period of time transpires wherein no validated packets have been received for address twenty three, the packet monitor can free this node within the data structure for more relevant information.

Packet monitor 304 is an optional stage within the invention and is useful for tracking the states and functions of other mobile electronic devices residing on the data bus 308. One distinct advantage of using packet monitoring stage 304 is for synchronizing states and settings with consisted or linked groups of decoders. For example, upon detection of the unique command pattern and the inherent consist address, the intelligent consisting state machine 303, can inform the packet monitor to upload the settings and states of the newly acquired consist into the operational variables and states 307 of processing unit 110A. This inherent advantage allows equipped mobile electronic devices entering a new consist to quickly synchronize all operational states, variables, and modes with the other mobile electronic devices already present within the consist. Automatic synchronization of such states, variables, and modes can greatly simplify the user setup experience when adding one or more devices to a consist.

Command sequence search stage, 305, broadly operates by monitoring the validated bus data and watches for a unique data command or pattern. Command sequence search stage 305 can be implemented to receive the validated bus data from a number of different sources, but is broadly illustrated to monitor the validated bus data that is present within the packet monitor 304 data structure. Once the data command or pattern has been received, the command sequence search stage activates the FOUND signal to inform subsequent stages that a valid consist address has been received. The precise nature and design of the unique data command or pattern can vary within different embodiments of the present invention.

In an example embodiment, decoder 100A and MR1 operate within a DCC system and the unique data command is implemented as a simple pattern of pre-existing DCC functions. For example, a specified DCC function F8 could be monitored to watch for a specific ON-OFF-ON-OFF-ON-OFF pattern, which could be easily triggered by an operator. Once this pattern of DCC F8 functions is received, the command sequence search stage 305 activates the FOUND signal thereby advancing the Intelligent Consisting state machine 303. The unique data command or pattern could be implemented as a specific command rather than a pattern of existing functions or commands. For example, again looking at a model railroading DCC communication system, a pre-defined unique command could be implemented, that upon receipt by an equipped decoder, would be detected by the command sequence search stage 305. In other words, embodiments can be produced to monitor for patterns of existing functions or variables, or can monitor for a newly defined command not previously used within the data communication system.

As stated above, the exact nature and construction of the unique data command or pattern is flexible within the methodologies contained within this disclosure, yet it should be clear to one skilled in the art that the unique data command or pattern should typically contain the address for the consisted group of mobile devices. In other words, the unique command or pattern should be transmitted such that the receiving command sequence search stage 305, or other data monitoring stages, can adequately determine the consist address. This architecture enables processing unit 108 to properly enter the consisted group of decoders and communicate using the newly acquired consist address.

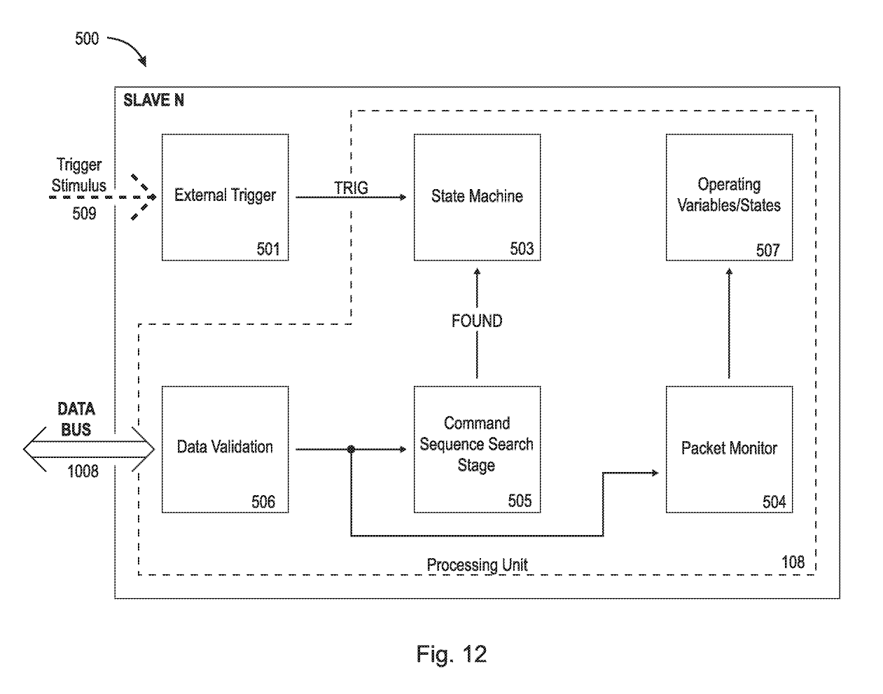

FIG. 12 is a block diagram outlining example processing architecture 500 of the decoder of FIG. 7. In FIG. 13, the inbound validated data coming from a standard data validation stage 306, flows directly to both the command sequence search stage 505, and the packet monitoring stage 504. In this configuration, all inbound validated data packets can be independently monitored by command sequence search stage 505 and packet monitor stage 504.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A plurality of decoders for model train locomotives or rolling stock, comprising:
a first decoder including:
a first memory element configured to store a first address uniquely identifying the first decoder; and,
a first processor configured to:
receive first data including a group identity address; and, store the group identity address in the first memory element; and,
a second decoder including:
a second memory element configured to store a second address uniquely identifying the second decoder; and,
a second processor configured to:
receive the first data; and,
store the group identity address in the second memory element, wherein:
the group identity address identifies a group of decoders;
the first decoder is arranged for installation in a first model train locomotive or rolling stock; and,
the second decoder is arranged for installation in a second model train locomotive or rolling stock.

2. The plurality of decoders of claim 1, wherein:
the group identity address is different from the first address; or,
the group identity address is different from the second address.

3. The plurality of decoders of claim 1, wherein:
the first data includes group operating instructions;
the first processor is configured to:
select, from the group operating instructions, first operating instructions for a first device for the first model train locomotive or rolling stock; and,
transmit the first operating instructions; and,
the second processor is configured to:
select, from the group operating instructions, second operating instructions for a second device for the second model train locomotive or rolling stock; and,
transmit the second operating instructions.

4. The plurality of decoders of claim 3, wherein:
the first processor is configured to store the group operating instructions in the first memory element; and,
the second processor is configured to store the group operating instructions in the second memory element.

5. The plurality of decoders of claim 1, wherein:
the first decoder includes:
a first data input; and,
a first sensor, separate from the first data input, the first sensor arranged to:
receive a first energy signal; and,
transmit a first trigger signal; and,
the first processor is configured to:
receive the first trigger signal; and,
in response to receiving the first trigger signal:
select the group identity address; and,
store the group identity address in the first memory element.

6. The plurality of decoders of claim 1, wherein:
the second decoder includes:
a second data input; and,
a second sensor, separate from the second data input, the second sensor arranged to:
receive a second energy signal; and,
transmit the first trigger signal; and,
the second processor is configured to:
receive the first trigger signal; and,
in response to receiving the first trigger signal:
select the group identity address; and,
store the group identity address in the second memory element.

7. The plurality of decoders of claim 5, wherein:
the first processor is configured to:
enter a search mode in response to receipt of the first trigger signal; and,
while in the search mode, ascertain that the first data includes the group identity address; and,
in response to ascertaining that the first data includes the group identity address, enter into a group operating mode.

8. The plurality of decoders of claim 7, wherein during the search mode, the first processor is configured to:
receive second data with the first address and first operating instructions for a first device for the first model train locomotive or rolling stock; and,
transmit the first operating instructions.

9. The plurality of decoders of claim 7, wherein:
the first data includes group operating instructions including second operating instructions for the first device; and,
during the search mode, the first processor is configured to:
receive the first data; and,
store the group operating instructions in the first memory element.

10. The plurality of decoders of claim 9, wherein:
the group operating instructions include first operating instructions for a first device for the first model train locomotive or rolling stock; and,
upon entry into the group operating mode, the first processor is configured to transmit the first operating instructions.

11. The plurality of decoders of claim 7, wherein during the search mode, the first processor is configured to:
receive operating instructions for a third decoder not included in the group in the group of decoders; and,
store the operating instructions in the first memory element.

12. The plurality of decoders of claim 7, wherein during the group operating mode, the first processor is configured to:
receive operating instructions for a third decoder not included in the group in the group of decoders; and,
store the operating instructions in the first memory element.

13. The plurality of decoders of claim 5, wherein,
the first sensor is arranged to:
receive a second energy signal; and,
transmit, in response to receiving the second energy signal, a second trigger signal;
the first processor is configured to:
receive the second trigger signal;
receive second data including the first address and first operating instructions, associated with the first address, for a first device for the first model train locomotive or rolling stock;
enter, in response to receiving the second trigger signal, an individual operation mode; and,
transmit the first operating instructions.

14. The plurality of decoders of claim 13, wherein:
during the individual operation mode, the first processor is configured to:
receive third data including the group identity address and group operating instructions for the group of decoders; and,
store the group operating instructions in the first memory element; and, the group operating instructions include second operating instructions for the first device.

15. The plurality of decoders of claim 14, wherein:
during the individual operation mode:
the first sensor is arranged to:
receive a third energy signal; and,
transmit, in response to receiving the third energy signal, the first trigger signal; and,
the first processor is configured to:
receive the first trigger signal; and,
transmit the second operating instructions stored in the memory element.

16. The plurality of decoders of claim 15, wherein the processor is arranged to:
compare the first and second operating instructions; and,
modify the first operating instructions as needed to avoid conflict with the second operating instructions.

17. The plurality of decoders of claim 13, wherein:
during the individual operation mode:
the first sensor is arranged to:
receive a third energy signal; and,
transmit, in response to receiving the third energy signal, the first trigger signal; and,
the first processor is configured to:
receive the first trigger signal;
receive third data including the group identity address and group operating instructions for the group of decoders;
enter into a group operating mode; and,
transmit second operating instructions, included in the group operating instructions, for the first device.

18. The plurality of decoders of claim 17, wherein the processor is arranged to:
compare the first and second operating instructions; and,
modify the first operating instructions as needed to avoid conflict with the second operating instructions.

19. The plurality of decoders of claim 5, wherein the first sensor is arranged to transmit the first trigger signal in response to magnetic energy or electromagnetic energy.

20. A plurality of decoders for model train locomotives or rolling stock, comprising:
a first decoder including:
a first data input;
a first sensor, separate from the first data input, the first sensor arranged to:
receive a first energy signal; and,
transmit, in response to receiving the first energy signal, a first trigger signal;
a first memory element configured to store a first address uniquely identifying the first decoder; and,
a first processor configured to:
receive first data including:
a group identity address; and,
group operating instructions including first group operation instructions, for first and second devices for first and second model train locomotive or rolling stock, respectively;
receive the first trigger signal; and,
in response to receiving the first trigger signal:
store the group identity address in the first memory element; and,
transmit the first operating instructions; and,
a second decoder including:
a second data input;
a second sensor, separate from the second data input, the second sensor arranged to:
receive a second energy signal; and,
transmit, in response to receiving the second energy signal, the first trigger signal;
a second memory element configured to store a second address uniquely identifying the second decoder; and,
a second processor configured to:
receive the first data;
receive the first trigger signal; and,
in response to receiving the first trigger signal:
store the group identity address in the first memory element; and,
transmit the second operating instructions wherein:
the group identity address identifies a group of decoders;
the first decoder is arranged for installation in a first model train locomotive or rolling stock; and,
the second decoder is arranged for installation in a second model train locomotive or rolling stock.

21. A decoder for model train locomotives or rolling stock, comprising:
a data input;
a sensor, separate from the data input, the sensor arranged to:
receive a first energy signal; and,
transmit, in response to receiving the first energy signal, a first trigger signal;
a memory element configured to store a first address identifying the decoder; and,
a processor configured to:
receive first data including a group identity address;
receive the first trigger signal; and,
in response to receiving the first trigger signal, store the group identity address in the memory element, wherein:
the sensor is arranged to:
receive a second energy signal; and,
transmit, in response to receiving the second energy signal, a second trigger signal; and,
the processor is configured to:
receive the second trigger signal;
receive second data including the first address and first operating instructions, associated with the first address, for a device for a model train locomotive or rolling stock; and,
transmit the first operating instructions, wherein the group identity address identifies a group of decoders.

22. The decoder of claim 21, wherein:
the first data includes group operating instructions for the group of decoders;
the group operating instructions include second operating instructions for the device; and,
in response to receiving the first trigger signal, the processor is configured to transmit the second operating instructions.

23. The decoder of claim 22, wherein the second operating instructions are different from the first operating instructions.

24. A computer-based method for operating a decoders for a model train locomotive or rolling stock, comprising:
receiving, using a sensor for the decoder, a first energy signal;
transmitting, using the sensor and in response to receiving the first energy signal, a first trigger signal;
storing, in a memory element for the decoder, a first address identifying the decoder;
receiving, using a processor for the decoder, first data including a group identity address;
receiving, using the processor, the first trigger signal;
in response to receiving the first trigger signal, storing, using the processor, the group identity address in the memory element;
receiving, using the sensor, a second energy signal;
transmitting, using the sensor and in response to receiving the second energy signal, a second trigger signal;
receiving, using a processor, the second trigger signal;
receiving, using the processor, second data including the first address and first operating instructions, associated with the first address, for a device for a model train locomotive or rolling stock;
transmitting, using the processor, the first operating instructions; and,
identifying, using the processor and the group identity address, a group of decoders.

25. The method of claim 24, wherein:
the first data includes group operating instructions for the group of decoders;
the group operating instructions include second operating instructions for the device, the method further comprising:
in response to receiving the first trigger signal, transmitting, using the processor, the second operating instructions.

26. The method of claim 25, wherein the second operating instructions are different from the first operating instructions.
